(19) United States
(12) Patent Application Publication
(10) Pub. No.: US 2019/0202017 A1
(43) Pub. Date: Jul. 4, 2019

(54) SELECTING DEVICE, SELECTING METHOD, AND PROGRAM

(71) Applicant: Mitsubishi Electric Corporation, Tokyo (JP)

(72) Inventor: Masakazu SAGASAKI, Tokyo (JP)

(73) Assignee: Mitsubishi Electric Corporation, Tokyo (JP)

(21) Appl. No.: 16/323,627

(22) PCT Filed: Jan. 27, 2017
(86) PCT No.: PCT/JP2017/002947

§ 371 Date: Feb. 6, 2019

(51) Int. Cl. B23Q 15/06; B23B 7/02; B23B 13/02; B23Q 5/36

(52) U.S. Cl. CPC B23Q 15/06; B23B 7/02; B23Q 2220/006; B23Q 5/36; B23Q 2220/002; B23B 13/022

(57) ABSTRACT

A selecting device causes a machine tool, which machines a workpiece from a bar material, to select another workpiece that the machine tool can machine from a leftover material, which is a remaining part of the bar material being machined, when a workpiece to be machined is not machinable from the leftover material. The selecting device includes: a selecting unit that refers to mountable tool data indicating a tool that can be mounted on a mount position of the machine tool, and causes the machine tool to select another workpiece that is machinable by the tool that can be mounted on the machine tool, in selecting another workpiece to be machined by the machine tool from the leftover material.

### FIELD

The present invention relates to a selecting device that selects a workpiece to be machined from a bar material, a selecting method therefor, and a program therefor.

### BACKGROUND

Automatic lathes that machine a plurality of workpieces from a bar material by cutting the bar material while moving the bar material along the longitudinal direction have been used. Typically, it is difficult for an automatic lathe to perform cutting to a very end of a bar material, which produces leftover materials at the end of cutting. Leftover materials cannot be cut by automatic lathes, and are therefore discarded.

Thus, an automatic lathe described in Patent Literature 1 includes a detecting unit that detects a remaining length of a bar material. For machining a plurality of workpieces of different lengths, the automatic lathe described in Patent Literature 1 makes a leftover material shorter by selecting a workpiece to be machined depending on the detection result of the detecting unit, that is, depending on the length of the leftover material.

### CITATION LIST

### Patent Literature

Patent Literature 1: Japanese Utility Model Registration No. 2578596

### SUMMARY

### Technical Problem

The automatic lathe described in Patent Literature 1, however, only selects and machines a workpiece depending on the length of a leftover material, and selects a machining program without considering the tools mounted on the machine tool, which causes problems that workpieces cannot be machined depending on the priority of the workpieces and that leftover materials cannot be used effectively.

The present invention has been made in view of the above, and an object thereof is to provide a selecting device capable of effectively use leftover materials.

### Solution to Problem

To solve the above described problem and achieve the object the present invention relates to a selecting device that causes a machine tool, which machines a workpiece from a bar material, to select another workpiece that the machine tool can machine from a leftover material, which is a remaining part of the bar material being machined, when a workpiece to be machined is not machinable from the leftover material, the selecting device comprising: a selecting unit to refer to mountable tool data indicating a tool that can be mounted on a mount position of the machine tool, and cause the machine tool to select another workpiece that is machinable by the tool that can be mounted on the machine tool, in selecting another workpiece to be machined by the machine tool from the leftover material.

### Advantageous Effects of Invention

A selecting device according to the present invention produces an advantageous effect of effective use of leftover materials.

### BRIEF DESCRIPTION OF DRAWINGS

FIG. 1 is a diagram illustrating a configuration of machining equipment including a numerical controller that is a selecting device according to a first embodiment.

FIG. 2 is a functional block diagram illustrating a configuration of the numerical controller that is the selecting device according to the first embodiment.

FIG. 3 is a side view illustrating a configuration of an automatic lathe of the machining equipment illustrated in FIG. 1.

FIG. 4 is a front view of a tool rest of the automatic lathe illustrated in FIG. 3.

FIG. 5 is a perspective view illustrating an example of a workpiece to be machined by the automatic lathe illustrated in FIG. 3.

FIG. 6 is a diagram explaining part of a machining program for machining a fourth workpiece stored in a storage unit of the numerical controller that is the selecting device according to the first embodiment.

FIG. 7 is a diagram explaining part of a machining program for machining a fifth workpiece stored in the storage unit of the numerical controller that is the selecting device according to the first embodiment.

FIG. 8 is a diagram explaining part of a machining program for machining a sixth workpiece stored in the storage unit of the numerical controller that is the selecting device according to the first embodiment.

FIG. 9 is a diagram illustrating an example of mountable tool data stored in the storage unit of the numerical controller illustrate in FIG. 2.

FIG. 10 is a flowchart illustrating a method by which a selecting unit of the numerical controller that is the selecting device according to the first embodiment selects another workpiece.

FIG. 11 is a diagram illustrating a configuration of machining equipment including a numerical controller that is a selecting device according to a second embodiment.

FIG. 12 is a functional block diagram illustrating a configuration of a production control computer that is a selecting device according to the second embodiment.

FIG. 13 is a functional block diagram illustrating a configuration of the numerical controller according to the second embodiment.

FIG. 14 is a flowchart illustrating a method by which a selecting unit of the production control computer that is the selecting device according to the second embodiment selects another workpiece.

FIG. 15 is a diagram illustrating a hardware configuration of the numerical controller that is the selecting device according to the first and second embodiments.

FIG. 16 is a diagram illustrating a hardware configuration of the production control computer that is the selecting device according to the second embodiment.

### DESCRIPTION OF EMBODIMENTS

A selecting device and a program according to certain embodiments will be described in detail below with reference to the drawings. Note that the present invention is not limited to the embodiments.

### First Embodiment

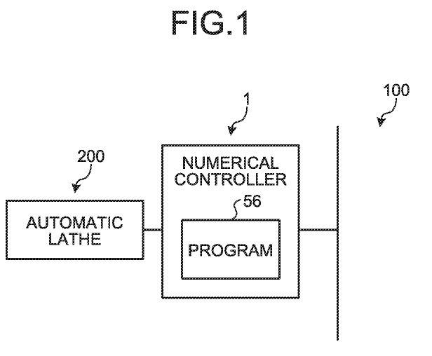

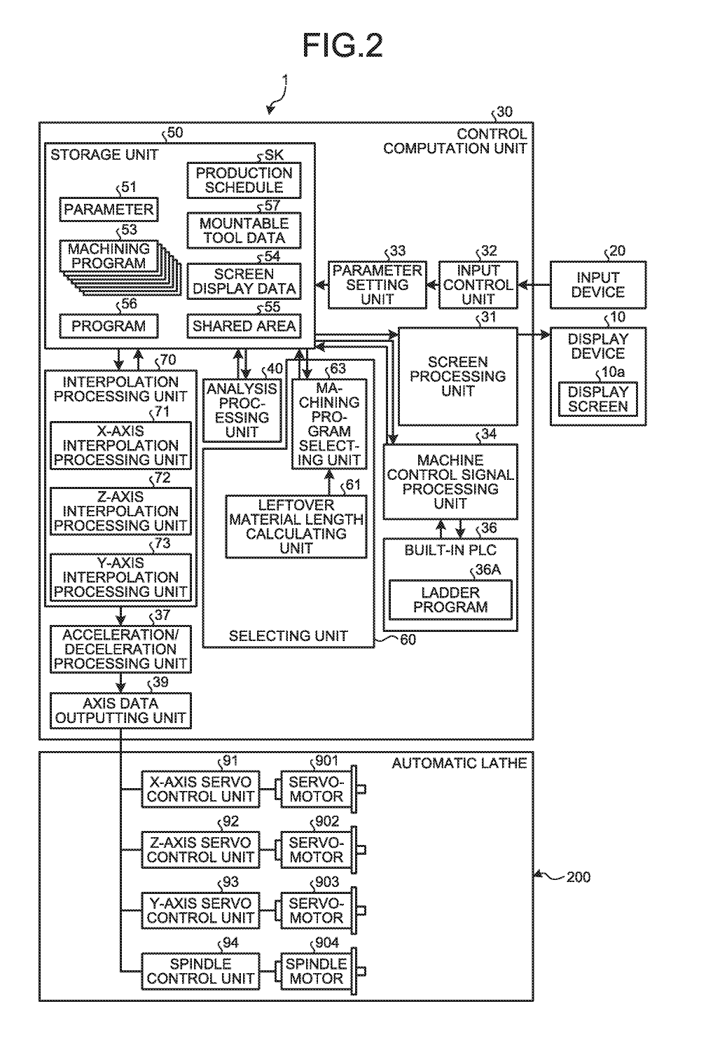

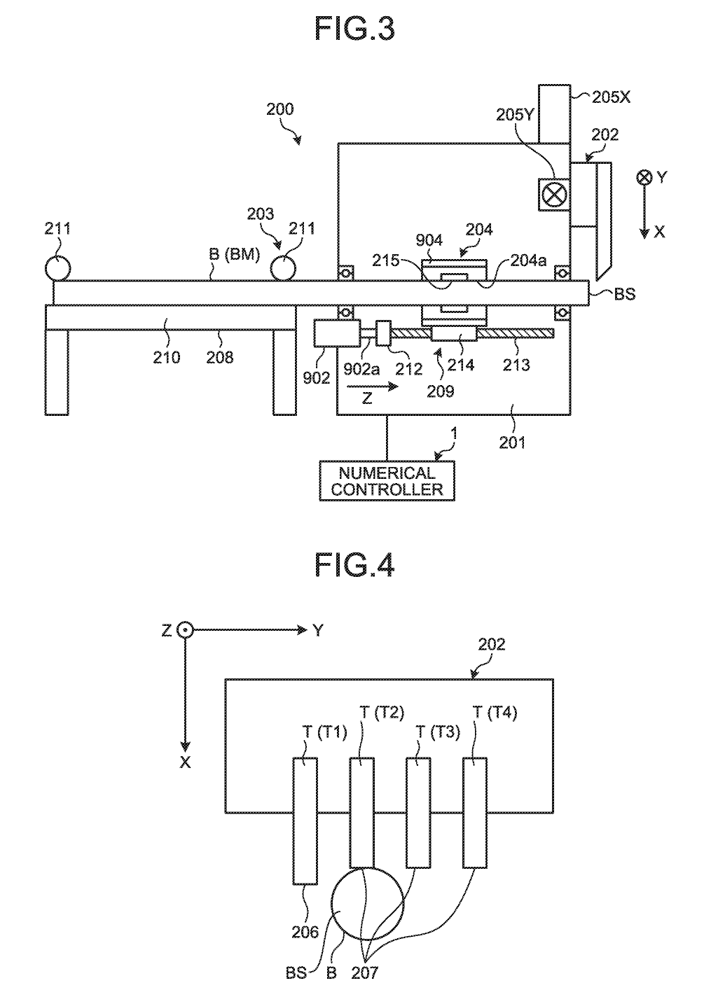

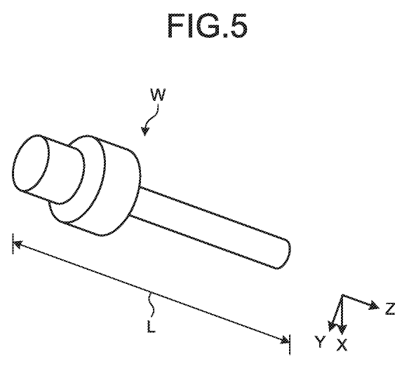

FIG. 1 is a diagram illustrating a configuration of machining equipment including a numerical controller that is a selecting device according to a first embodiment. FIG. 2 is a functional block diagram illustrating a configuration of the numerical controller that is the selecting device according to the first embodiment. FIG. 3 is a side view illustrating a configuration of an automatic lathe of the machining equipment illustrated in FIG. 1. FIG. 4 is a front view of a tool rest of the automatic lathe illustrated in FIG. 3. FIG. 5 is a perspective view illustrating an example of a workpiece to be machined by the automatic lathe illustrated in FIG. 3. A member on which a tool is mounted is not limited to the tool rest 202 illustrated in FIG. 3, but may alternatively be a turret.

The numerical controller 1, which is the selecting device according to the first embodiment, controls the automatic lathe 200, which is a machine tool constituting the machining equipment 100 as illustrated in FIGS. 1 and 2. As illustrated in FIG. 1, the machining equipment 100 includes the automatic lathe 200, and the numerical controller 1 that controls each automatic lathe 200. The number of automatic lathes 200 included in the machining equipment 100 is not limited, and may be plural or one.

As illustrated in FIG. 3, the automatic lathe 200 includes: a main unit 201 installed on a floor of a factory; the tool rest 202 movably mounted on the main unit 201; a material supply unit 203 that supplies a columnar or prism-shaped bar material B toward the tool rest 202; a headstock 204 that rotates the bar material B about a central axis of the bar material B; an X-direction feed mechanism 205X that moves the tool rest 202 in an X direction relative to the main unit 201; and a Y-direction feed mechanism 205Y that moves the tool rest 202 in a Y direction toward the main unit 201. The tool rest 202 is supported on the main unit 201 by a linear guide such that the tool rest 202 is movable in the Y direction parallel to the horizontal direction, and supported on the main unit 201 by a linear guide such that the tool rest 202 is movable in the X direction parallel to the vertical direction.

As illustrated in FIG. 4, a positioning tool 206 for positioning and machining tools 207 that are tools for machining are mounted on the tool rest 202. One positioning tool 206 and a plurality of machining tools 207 are mounted on the tool rest 202. In the first embodiment, three machining tools 207 are mounted on the tool rest 202. On the tool rest 202, the positioning tool 206 and the machining tools 207 are arranged at intervals in the Y direction. In the first embodiment, a position T on the tool rest 202 on which the positioning tool 206 is mounted will be hereinafter referred to as a first mount position T1. Positions T on the tool rest 202 on which the three machining tools 207 are mounted will be hereinafter referred to as a second mount position T2; a third mount position T3; and a fourth mount position T4.

The material supply unit 203 supplies a bar material B toward the tool rest 202 along a Z direction parallel to the horizontal direction and perpendicular to the Y direction. The bar material B is made of metal in a columnar shape with a constant outer diameter. In the first embodiment, the bar material B is not limited to a columnar shape but may be prismatic in shape. The material supply unit 203 includes a guide part 208 that guides the bar material B, and a feeding part 209 that moves the bar material B fixed with a chuck 215. The guide part 208 includes: a guide body 210 installed on the floor of the factory; and guide rollers 211 rotatably provided on the guide body 210, such that the guide rollers 211 hold the bar material B between the guide rollers 211 and the guide body 210 and guides the moving direction of the bar material B. The guide part 208 has a structure in which the bar material B is pushed with a pushing shaft, which is not illustrated.

As illustrated in FIG. 3, the feeding part 209 includes: a servomotor 902 mounted on the main unit 201; a ball screw shaft 213 mounted on an output shaft 902a of the servomotor 902 with a joint 212 therebetween; and a Z-axis servo control unit 92 illustrated in FIG. 2, which controls the servomotor 902 in accordance with a Z-axis moving amount command input from the numerical controller 1. The ball screw shaft 213 is arranged in parallel with the Z direction. A nut 214 on which the headstock 204 is mounted is screwed onto the ball screw shaft 213. The Z-axis servo control unit 92 is a servo amplifier that converts the Z-axis moving amount command into a three-phase current and outputs the three-phase current to the servomotor 902.

The headstock 204 is formed in a ring shape with an inner hole 204a through which the bar material B passes. The headstock 204 includes: the chuck 215 that holds the bar material B; a spindle motor 904 capable of rotating the chuck 215 holding the bar material B about the central axis of the bar material B; and a spindle control unit 94 illustrated in FIG. 2, which controls the spindle motor 904 in accordance with a rotation command input from the numerical controller 1. The spindle control unit 94 is a servo amplifier that converts the rotation command into a three-phase current and outputs the three-phase current to the spindle motor 904. Note that the rotation command is a movement command in the rotating direction to rotate the bar material B about the central axis of the bar material B.

The material supply unit 203 moves the headstock 204 and the bar material B in the Z direction in such a manner that the servomotor 902 rotates the ball screw shaft 213 with the chuck 215 of the headstock 204 chucking the bar material B. In the headstock 204, the spindle motor 904 rotates the bar material B about the central axis with the chuck 215 chucking the bar material B.

The X-direction feed mechanism 205X moves the tool rest 202 in the X direction. The X-direction feed mechanism 205X includes: a servomotor 901 illustrated in FIG. 2, which moves the tool rest 202 in the X direction; and an X-axis servo control unit 91 illustrated in FIG. 2, which controls the servomotor 901 in accordance with an X-axis moving amount command input from the numerical controller 1. The X-axis servo control unit 91 is a servo amplifier that converts the X-axis moving amount command into a three-phase current and outputs the three-phase current to the servomotor 901. The Y-direction feed mechanism 205Y moves the tool rest 202 in the Y direction. The Y-direction feed mechanism 205Y includes: a servomotor 903 illustrated in FIG. 2, which moves the tool rest 202 in the Y direction; and a Y-axis servo control unit 93 illustrated in FIG. 2, which controls the servomotor 903 in accordance with a Y-axis moving amount command input from the numerical controller 1. The Y-axis servo control unit 93 is a servo amplifier that converts the Y-axis moving amount command into a three-phase current and outputs the three-phase current to the servomotor 903.

The automatic lathe 200 according to the first embodiment brings an end face BS of the bar material B into contact with the positioning tool 206 to position the bar material B before machining a workpiece W from the bar material B. The automatic lathe 200 controls the servomotors 902, 903, and 901 in accordance with the Z-axis moving amount command, the Y-axis moving amount command, and the X-axis moving amount command generated by the numerical controller 1 by executing machining programs 53, which are illustrated in FIG. 2, for machining a workpiece W. The automatic lathe 200 also controls the spindle motor 904 in accordance with the rotation command and controls the chuck 215. The automatic lathe 200 controls: the servomotors 901, 902, and 903: the spindle motor 904; and the chuck 215; so that the chuck 215 of the headstock 204 chucks the bar material B. And the feeding part 209 supplies the bar material B toward the tool rest 202 while the spindle motor 904 rotates the bar material B, and a machining tool 207 mounted on the tool rest 202 cuts the bar material B to machine a workpiece W, one example of which is illustrated in FIG. 5, from the bar material B.

In the first embodiment, the automatic lathe 200 is a so-called Swiss-type automatic lathe in which the headstock 204 moves in the Z direction as described above, however the automatic lathe 200 may be a fixed automatic lathe in which the headstock 204 is fixed. Typically, an automatic lathe 200 of the fixed automatic type includes a turret instead of the tool rest 202. In addition, the shape of the workpiece W machined by the automatic lathe 200 is not limited to that illustrated in FIG. 5, but the automatic lathe 200 machines workpieces W of various shapes. Note that the length L in the Z direction of the workpiece W is a machining length L of the workpiece W.

The numerical controller 1 illustrated in FIG. 2 is associated with the automatic lathe 200, and is a computer that performs numerical control on the associated automatic lathe 200. As illustrated in FIG. 2, the numerical controller 1 includes a display device 10, an input device 20, and a control computation unit 30 that is a control unit. The display device 10 includes a display screen 10a that displays information. The input device 20 is capable of inputting information to the control computation unit 30.

The numerical controller 1 selects a machining program 53 from among a plurality of machining programs 53 depending on an input of information for causing the automatic lathe 200 to machine the workpiece W, and automatically starts. In automatic starting, an analysis processing unit 40 analyzes the machining program 53, and passes the analysis result to an interpolation processing unit 70 via a shared area 55. The interpolation processing unit 70: based on the analysis result, generates the X-axis moving amount command, the Y-axis moving amount command, the Z-axis moving amount command, and the rotation command; and supplies the generated commands, with an acceleration/deceleration command added at an acceleration/deceleration processing unit 37, to the servo control units 91, 92, and 93 and the spindle control unit 94 via an axis data outputting unit 39. The X-axis servo control unit 91, the Y-axis servo control unit 92, the Z-axis servo control unit 93, and the spindle control unit 94 drive the servomotors 901, 902, and 903, and the spindle motor 904 in accordance with the X-axis moving amount command, the Y-axis moving amount command, the Z-axis moving amount command, and the rotation command, respectively, input from the control computation unit 30.

The control computation unit 30 includes: a built-in programmable logic controller (PLC) 36; a machine control signal processing unit 34; a storage unit 50; the analysis processing unit 40; the interpolation processing unit 70; the acceleration/deceleration processing unit 37; the axis data outputting unit 39; an input control unit 32; a screen processing unit 31; a parameter setting unit 33; and a selecting unit 60.

The storage unit 50 is a storage device in the numerical controller 1. The storage unit 50 stores parameters 51, a plurality of machining programs 53, and screen display data 54, and includes the shared area 55 as a working space. The storage unit 50 stores: the machining programs 53 associated with workpieces W to be machined by the automatic lathe 200; a program 56 of a selecting method to be executed by the selecting unit 60 to select another workpiece W; and mountable tool data 57 indicating tools mounted on respective mount positions T of the automatic lathe 200.

In the present embodiment, a mountable tool refers to a tool that can be used for machining a workpiece W, and in a case where the machine tool is a Swiss-type automatic lathe or a fixed automatic lathe, a mountable tool refers to a tool mounted on the tool rest 202 illustrated in FIG. 3 or a tool mounted on a turret. In the present embodiment, in the case where the machine tool is a Swiss-type automatic lathe or a fixed automatic lathe, mounting a tool on the machine tool refers to attaching a tool onto the tool rest 202 or the turret of the machine tool.

In the present embodiment, the machine tool may be a combined lathe with an automatic tool changer (ATC) with a bar loader. In this case, a mountable tool corresponds to a tool accommodated in the ATC. In a case where the machine tool is a combined lathe with an ATC with a bar loader, mounting a tool on the machine tool refers to attaching a tool onto a spindle head of the machine tool.

When the machine tool is a combined lathe with an ATC with a bar loader the machine tool includes a machining unit including the spindle head, the bar loader, and the ATC. The bar loader supplies a workpiece to the machining unit. A tool is mounted on the spindle head. The spindle head machines the workpiece W supplied from the bar loader by using the tool mounted thereon. The ATC accommodates a plurality of tools. The ATC mounts a tool to be used for machining the workpiece W on the spindle head from among the accommodated tools. In addition, the ATC detaches a tool mounted on the spindle head and accommodates the detached tool.

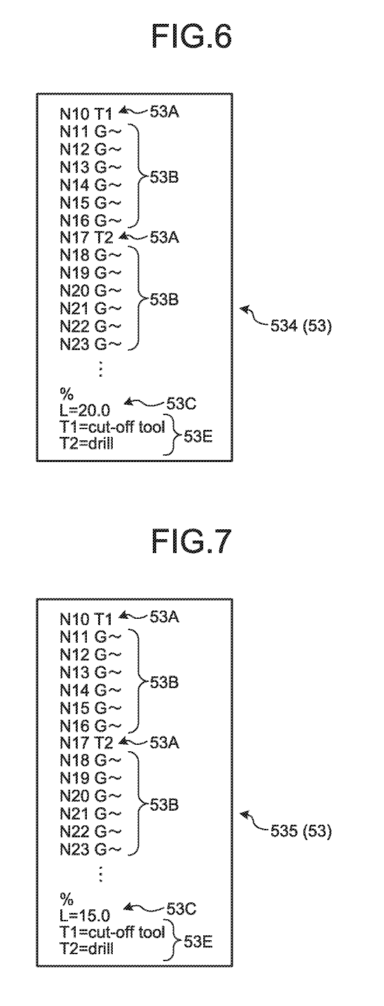

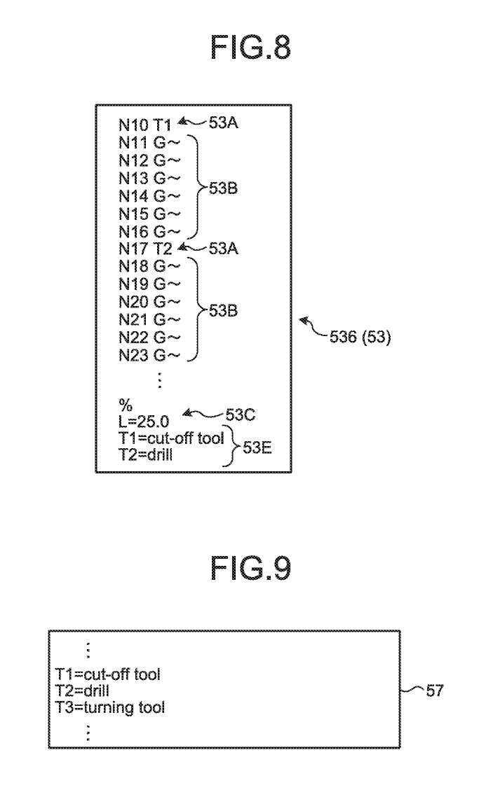

FIGS. 6 to 8 are diagrams explaining part of machining programs for machining workpieces stored in the storage unit of the numerical controller that is the selecting device according to the first embodiment. FIG. 9 is a diagram illustrating an example of the mountable tool data stored in the storage unit of the numerical controller illustrate in FIG. 2.

In the first embodiment, the machining programs 53 stored in the storage unit 50 include machining programs 534, 535, and 536 for machining different workpieces. A workpiece W machined by the machining program 534 is different from workpieces W machined by the machining programs 535 and 536 in at least one of size and shape. A workpiece W machined by the machining program 535 is different from a workpiece W machined by the machining program 536 in at least one of size and shape. The workpieces W machined by the machining programs 534, 535, and 536 correspond to other workpieces machined from a bar material B.

The machining programs 53 are described using T codes 53A, S codes, M codes, and G codes 53B. A T code 53A indicates selection of a machining tool 207 used for machining, and indicates a mount position T on which a machining tool 207 to be used for machining is mounted in the first embodiment. An S code is a rotation command for the spindle, and an M code is a command for controlling a machine component such as turning on/off of a coolant. These are processed by the built-in PLC 36 and the machine control signal processing unit 34.

In the first embodiment, the machining programs 534 and 535 and the machining program 536 illustrated in FIGS. 6 to 8 describe the T codes 53A using the mount positions T1 and T2, but the T codes 53A are not limited thereto. A G code 53B describes a manner in which a machining tool 207 is to be moved relative to a bar material B for machining the bar material B into a workpiece W by the automatic lathe 200. In addition, the machining programs 53 describe information 53C indicating machining lengths L of workpieces W that the machining programs 53 are to machine in predetermined blocks. Specifically, the information 53C indicating a machining length L of a workpiece W is part of a machining program 53 for the automatic lathe 200 to machine the workpiece W, and is stored in the storage unit 50. In the first embodiment, the workpiece W to be machined is drawn by a simulation function of the numerical controller 1, and the machining length L may be calculated based on a result of the drawing.

Machining tool name information 53E indicating the name of a machining tool 207 to be used for machining is described in a preset block in the machining program 534, the machining program 535, and the machining program 536.

The mountable tool data 57 illustrated in FIG. 9 indicates the names of the positioning tool 206 and the machining tools 207 that can be mounted on the respective mount positions T of the tool rest 202 of the automatic lathe 200. In the first embodiment, the mountable tool data 57 associates the mount positions T1, T2, and T3 with the names of the machining tools 207.

Upon receiving information specifying a workpiece W to be machined by the automatic lathe 200 from the input device 20, the control computation unit 30 selects a machining program 53 for machining the workpiece W specified by the information received from the input device 20 from among the machining programs 53 stored in the storage unit 50, and automatically starts the selected machining program 53. A signal for automatic starting is input to the machine control signal processing unit 34 via the built-in PLC 36. The machine control signal processing unit 34 instructs the analysis processing unit 40 via the storage unit 50 to start analysis of the machining program 53.

The analysis processing unit 40 reads out the machining program 53 from the storage unit 50, and performs an analysis process on each block (each line) of the machining program 53. When a T code 53A, an S code or an M code other than G codes 53B is included in an analyzed block (line), the analysis processing unit 40 passes the analysis result to the built-in PLC 36 via the storage unit 50 and the machine control signal processing unit 34. When a G code 53B is included in the analyzed line, the analysis processing unit 40 outputs the analysis result to the interpolation processing unit 70.

When a T code 53A or an M code is input, the built-in PLC 36 performs machine control according to a ladder program 36A. Thereafter, the built-in PLC 36 outputs a signal for executing a next block of the machining program 53 to the machine control signal processing unit 34.

The interpolation processing unit 70 receives a position command being an analysis result from the analysis processing unit 40, performs an interpolation process in response to the position command, and supplies a moving amount being a result of the interpolation process to the acceleration/deceleration processing unit 37. The interpolation processing unit 70 includes: an X-axis interpolation processing unit 71 that performs an interpolation process in the X direction; a Y-axis interpolation processing unit 73 that performs an interpolation process in the Y direction; and a Z-axis interpolation processing unit 72 that performs an interpolation process in the Z direction.

The acceleration/deceleration processing unit 37 performs an acceleration/deceleration process on the result of the interpolation process supplied from the interpolation processing unit 70. The acceleration/deceleration processing unit 37 outputs the results of the acceleration/deceleration process on the X axis, the Y axis, and the Z axis to the axis data outputting unit 39. The axis data outputting unit 39 outputs the input results of the acceleration/deceleration process to the servomotors 901, 902, and 903 via the servo control units 91, 92, and 93. A step command is output to the spindle without the acceleration/deceleration process.

In a case where the automatic lathe 200 cannot machine a leftover material BM illustrated in FIG. 3 of the bar material B into a workpiece W to be machined subsequently, that is, a workpiece W is not machinable because the length of the leftover material BM is not sufficient, the selecting unit 60 of the numerical controller 1 selects another workpiece W into which the automatic lathe 200 can machine from the leftover material BM of the bar material B. The leftover materials BM is a remaining part of the bar material B machined into at least one workpiece W.

The control computation unit 30 detects the initial length of a bar material B or register the initial length in the storage unit 50, and subtracts the machining length L of a workpiece W currently being machined each time machining is performed to calculate the length of the remaining leftover material BM, for example. When the length of the leftover material BM has become shorter than the machining length L of the workpiece W to be machined, the control computation unit 30 detects that the length of the leftover material BM has become insufficient. A leftover material length calculating unit 61 of the control computation unit 30 is a leftover material length detecting unit that detects the length of a leftover material BM.

As illustrated in FIG. 2, the selecting unit 60 includes the leftover material length calculating unit 61 and a machining program selecting unit 63. The leftover material length calculating unit 61 calculates the length of a leftover material BM. In the first embodiment, the leftover material length calculating unit 61 detects or register the length of a bar material B, and subtracts the machining length L of a workpiece W currently being machined each time machining is performed to calculate the length of a leftover material BM.

The machining program selecting unit 63 determines whether or not a workpiece W to be machined can be machined from the leftover material BM based on the length of the leftover material BM calculated by the leftover material length calculating unit 61 and the machining length L of the workpiece W to be machined subsequently described in the machining program 53. When the length of the leftover material BM calculated by the leftover material length calculating unit 61 is equal to or longer than the machining length L of the workpiece W to be machined subsequently, the machining program selecting unit 63 determines that the workpiece W to be machined subsequently can be made. Upon determining that the workpiece W to be machined subsequently is machinable from the leftover material BM, the machining program selecting unit 63 makes the control computation unit 30 continue execution of the machining program 53.

When the length of the leftover material BM calculated by the leftover material length calculating unit 61 is shorter than the machining length L of the workpiece W to be machined subsequently described in the machining program 53, the machining program selecting unit 63 determines that the workpiece W to be machined subsequently, that is, the workpiece W to be machined cannot be machined. The workpiece W to be machined subsequently is not particularly limited, and may be a workpiece W defined in a production schedule SK stored in the storage unit 50 illustrated in FIG. 2, for example.

Upon determining that the workpiece W to be machined subsequently is not machinable from the leftover material BM, the machining program selecting unit 63 acquires the machining lengths L described in machining programs 53 for machining other workpieces W, and selects another workpiece W that is machinable from the leftover material BM. The machining program selecting unit 63 selects another workpiece W with a machining length L equal to or shorter than the length of the leftover material BM. In this manner, the selecting unit 60 selects another workpiece W that is machinable from the leftover material BM from among a plurality of other workpieces W based on the information 53C indicating the machining lengths L of other workpieces W stored in the storage unit 50 and the length of the leftover material BM.

When a plurality of other workpieces W can be selected, the machining program selecting unit 63 selects a machining program 53 for machining one of other workpieces W. The machining program selecting unit 63 refers to the selected machining program 53 and the mountable tool data 57, and determines whether or not machining tool name information 53E that matches with part of the mountable tool data 57 is described in the selected machining program 53. When the machining tool name information 53E that matches with part of the mountable tool data 57 is described in the selected machining program 53, the machining program selecting unit 63 executes the selected machining program 53 to instruct to machine the workpiece W. In this case, the machining program selecting unit 63 automatically starts the selected machining program 53.

Next, a selecting method by which the numerical controller 1 according to the first embodiment selects another workpiece W when a workpiece W to be machined, that is, a workpiece W to be machined is not machinable from a leftover material BM of a bar material B will be explained. The selecting method is implemented by the selecting unit 60 of the numerical controller 1 illustrated in FIG. 2 by executing the program 56 stored in the storage unit 50.

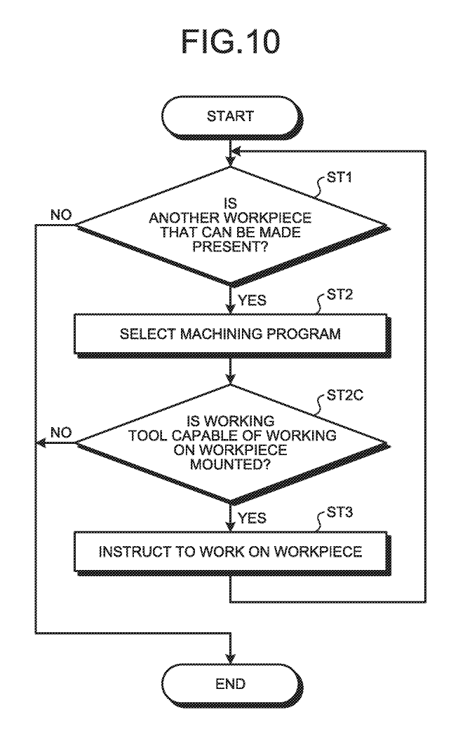

FIG. 10 is a flowchart illustrating the method by which the selecting unit of the numerical controller that is the selecting device according to the first embodiment selects another workpiece. The selecting unit 60 of the numerical controller 1 according to the first embodiment performs step ST1 to determine whether or not another workpiece W that is machinable from the leftover material BM of the bar material B and that is not specified to be machined next is present. If another workpiece W that is machinable from the leftover material BM of the bar material B and that is not specified to be machined next is present (step ST1: Yes), the selecting unit 60 selects the machining program 53 for machining this workpiece W (step ST2).

The selecting unit 60 refers to the mountable tool data 57, and determines whether or not a machining tool 207 capable of machining the workpiece W selected in step ST2 is mounted on the tool rest 202 (step ST2C). The selecting unit 60 refers to the machining program 53 selected in step ST2 and the mountable tool data 57, and determines whether or not machining tool name information 53E that matches with part of the mountable tool data 57 is described in the machining program 53 selected in step ST2.

Upon determining that no machining tool name information 53E that completely matches with part of the mountable tool data 57 is described in the machining program 53 selected in step ST2, the selecting unit 60 determines that no machining tool 207 capable of machining is mounted on the tool rest 202 (step ST2C: No), and terminates the selecting method.

Upon determining that machining tool name information 53E that completely matches with part of the mountable tool data 57 is described in the machining program 53 selected in step ST2, the selecting unit 60 determines that a machining tool 207 capable of machining is mounted on the tool rest 202 (step ST2C: Yes). The selecting unit 60 executes the machining program 53 selected in step ST2 to instruct to machine the workpiece W (step ST3), and returns to step ST1.

The selecting unit 60 repeats steps ST1 to ST3 until the selecting unit 60 determines that no machining program 53 for machining a workpiece W that is machinable from the leftover material BM of the bar material B is present in step ST1 (step ST1: No). In this manner, in selecting another workpiece W to be machined from a leftover material BM by the automatic lathe 200, the selecting unit 60 of the numerical controller 1 refers to the mountable tool data 57, and selects a workpiece W that can be machined by a machining tool 207 mounted on the automatic lathe 200.

Since the selecting unit 60 refers to the mountable tool data 57 and selects a workpiece W that can be machined by a machining tool 207 mounted on the automatic lathe 200 in selecting a workpiece W to be machinable from a leftover material BM from among a plurality of other workpieces W, the selected workpiece W can be reliably machined from the leftover material BM, which allows the leftover material BM to be effectively used.

While the information 53C indicating the machining lengths and the machining tool name information 53E are described in the machining programs 534, 535, and 536 in the first embodiment, the information 53C indicating the machining lengths and the machining tool name information 53E may be associated with the respective machining programs 53 and stored in the storage unit 50 of the storage unit 50 of the numerical controller 1. In addition, while the mountable tool data 57 are stored in the storage unit 50 of the numerical controller 1 in the first embodiment, the mountable tool data 57 may be stored in the storage unit 50 as part of the machining programs 53 stored in the storage unit 50 in the numerical controller 1 that controls the automatic lathe 200.

In the first embodiment, in selecting another workpiece W to be machined from a leftover material BM from among a plurality of other workpieces W, the selecting unit 60 refers to the mountable tool data 57 and selects a workpiece W that can be machined by a machining tool 207 mounted on the automatic lathe 200. In a case where a plurality of other workpieces W can be machinable from a leftover material BM, the selecting unit 60 may select a workpiece W further based on priority. The priority indicates a priority level of a workpiece W to be machinable from a leftover material BM in a predetermined block that is set in advance. Information indicating the priority is priority level information. The priority level information is described in the machining programs 534, 535, and 536 for machining other workpieces W. Thus, the priority level information is described in the machining programs 53. The priority level information is therefore stored in the storage unit 50. In the first embodiment, the priority level information is represented by zero or a natural number. The priority level information of zero indicates the highest priority.

In selecting another workpiece W to be machined from a leftover material BM from among a plurality of other workpieces W, the selecting unit 60 refers to the mountable tool data 57 and selects a workpiece W that is machinable by a machining tool 207 mounted on the automatic lathe 200. In a case where a plurality of other workpieces W are selected, the selecting unit 60 reads the priority level information from the machining program 53 associated with each of the selected workpieces W, and selects a workpiece W with high priority, or a workpiece W with the highest priority in the first embodiment.

While the priority level information is described in the machining programs 53 and stored in the storage unit 50 in the first embodiment, the priority level information may be stored in a storage unit of a production control computer provided externally to the numerical controller 1 instead of being described in the machining programs 53. While the mountable tool data 57 are stored in the storage unit 50 of the numerical controller 1 in the first embodiment, the mountable tool data 57 may be stored in a computer or a server in a network. In this case, the numerical controller 1 acquires the mountable tool data 57 stored in the computer or the server in the network via the input control unit 32 connected to the network.

The first embodiment has been described above; the configurations described in the first embodiment are also applicable below where appropriate.

### Second Embodiment

A second embodiment is similar to the first embodiment, but is different therefrom in that a production control computer includes a selecting unit that selects another workpiece W to be machinable from a leftover material BM from among a plurality of other workpieces W. Next, the second embodiment will be described with reference to the drawings. In the description below, components that are the same as the components in the first embodiment will be represented by the same reference numerals, and description thereof will not be repeated.

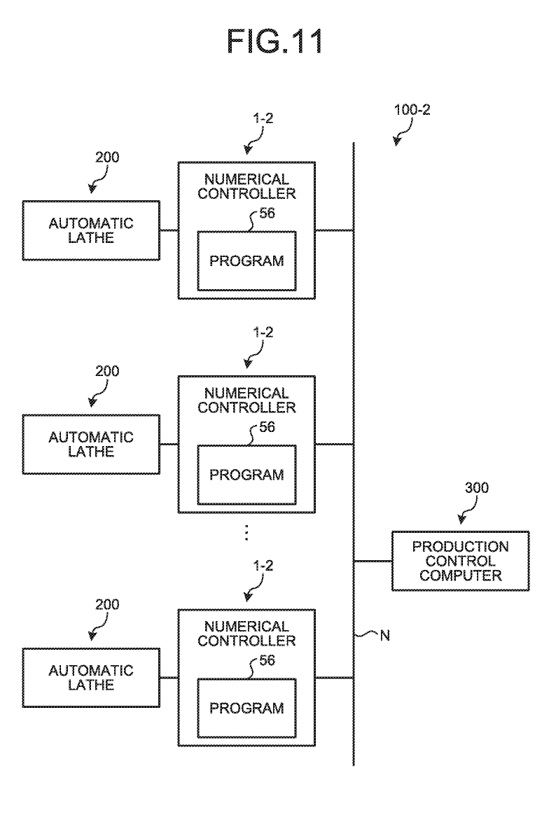

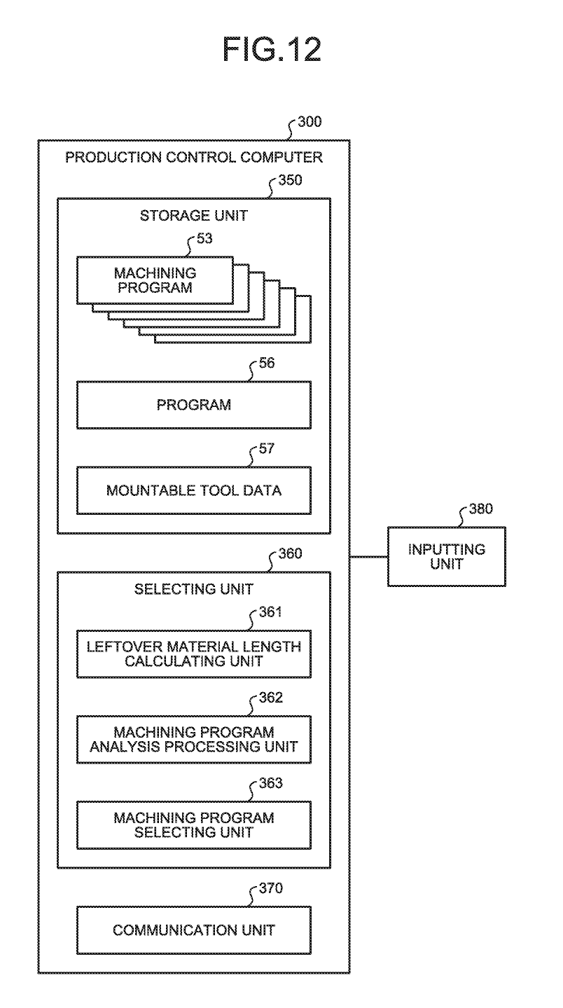

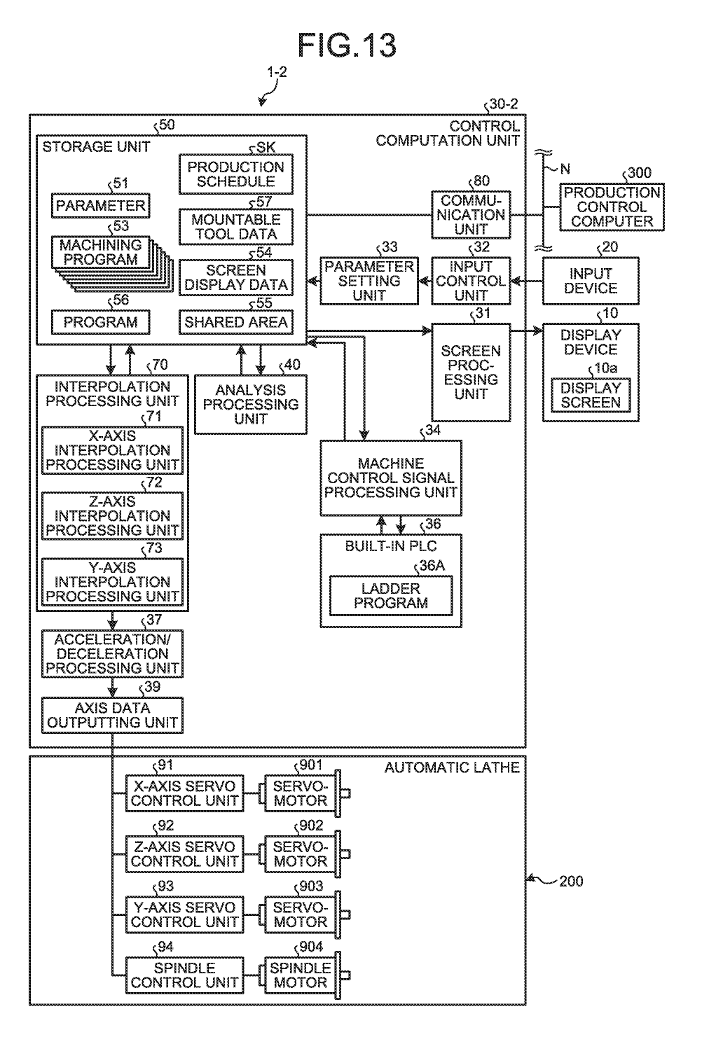

FIG. 11 is a diagram illustrating a configuration of machining equipment including a numerical controller that is a selecting device according to the second embodiment. FIG. 12 is a functional block diagram illustrating a configuration of a production control computer that is a selecting device according to the second embodiment. FIG. 13 is a functional block diagram illustrating a configuration of the numerical controller according to the second embodiment.

In the second embodiment, machining equipment 100-2 includes numerical controllers 1-2 and a production control computer 300 that is an external computer, which are connected to a computer network N. The computer network N is a network that connects the production control computer 300 and the numerical controllers 1-2 in such a manner that the production control computer 300 and the numerical controllers 1-2 can mutually communicate. The numerical controllers 1-2 and the production control computer 300 communicate with each other via the computer network N. The computer network N is a local area network (LAN) in the second embodiment, but is not limited thereto. While a plurality of numerical controllers 1-2 are connected to the computer network N in the second embodiment, the number of numerical controllers 1-2 connected to the computer network N may be one. The other configuration of the machining equipment 100-2 is similar to that of the machining equipment 100 in the first embodiment.

The selecting device according to the second embodiment is the production control computer 300. The production control computer 300 that is an external computer is a computer external to the numerical controllers 1-2. As illustrated in FIG. 12, the production control computer 300, or more specifically, a storage unit 350 stores the mountable tool data 57. The mountable tool data 57 indicate the names of the positioning tool 206 and the machining tools 207 mounted on the respective mount positions T of the tool rest 202 of each automatic lathe 200. The machining tool name information 53E is described in a preset block in each machining program 53 stored in the storage unit 350 similarly to the first embodiment. In a case where the workpiece W to be machined subsequently by the automatic lathe 200 is a workpiece W specified in a production schedule, the storage unit 350 stores the production schedule.

As illustrated in FIG. 12, a selecting unit 360 of the production control computer 300 includes a leftover material length calculating unit 361, a machining program analysis processing unit 362, and a machining program selecting unit 363. The leftover material length calculating unit 361 has functions similar to the functions of the leftover material length calculating unit 61 of the numerical controller 1 illustrated in FIG. 2. The machining program analysis processing unit 362 simulates the machining length L of a workpiece W. In a case where the analysis processing unit 40 of the numerical controller 1-2 simulates the machining length L of a workpiece W, the selecting unit 360 need not include the machining program analysis processing unit 362. The machining program selecting unit 363 has functions similar to the functions of the machining program selecting unit 63 of the numerical controller 1 illustrated in FIG. 2.

In a case where the workpiece W to be machined is not machinable from a bar material B, the selecting unit 360 selects another workpiece W. The selecting unit 360 of the production control computer 300 refers to the mountable tool data 57 and the machining program 53 for machining the selected workpiece W to determine whether or not a machining tool 207 capable of machining the selected workpiece W is mounted, and repeats the selection of a workpiece W until such a machining tool 207 is determined to be mounted.

Since the selecting unit 360 of the production control computer 300 refers to the mountable tool data 57 and selects a workpiece W that is machinable by a machining tool 207 mounted on the automatic lathe 200 in selecting a workpiece W to be machinable from a leftover material BM from among a plurality of other workpieces W, the selected workpiece W can be reliably machined from the leftover material BM, which allows the leftover material BM to be effectively used. In addition, in the second embodiment, the selecting unit 360 of the production control computer 300 may select a workpiece W that can be machined by a machining tool 207 mounted on the automatic lathe 200 further based on priority, similarly to the first embodiment.

In the second embodiment, as illustrated in FIG. 13, the numerical controller 1-2 does not include the selecting unit 60, which is included in the numerical controller 1 of the first embodiment illustrated in FIG. 2. The numerical controller 1-2 includes a communication unit 80 in a control computation unit 30-2. The communication unit 80 is connected to the computer network N. The numerical controller 1-2 and the production control computer 300 communicate with each other via the communication unit 80 and the computer network N.

Next, a selecting method by which the production control computer 300 according to the second embodiment selects another workpiece W when a workpiece W to be machined, that is, a workpiece W to be machined is not machinable from a leftover material BM of a bar material B will be explained. The selecting method is implemented by the selecting unit 360 of the production control computer 300 illustrated in FIG. 12 by executing the program 56 stored in the storage unit 350.

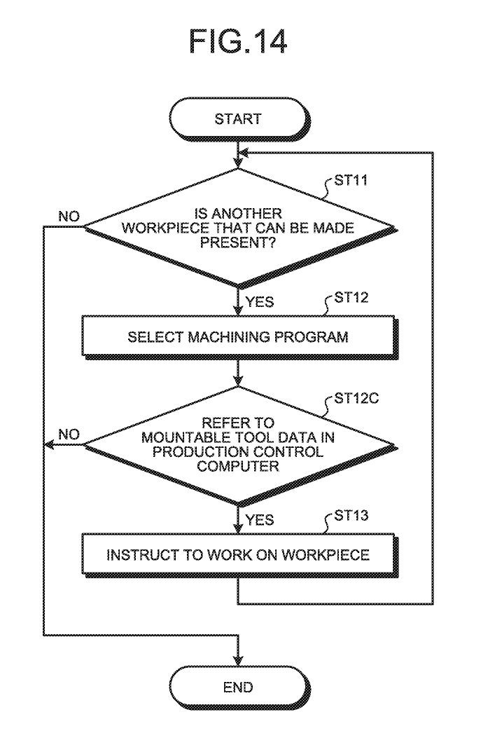

FIG. 14 is a flowchart illustrating a method by which the selecting unit of the production control computer that is the selecting device according to the second embodiment selects another workpiece. Since steps ST11, ST12, and ST13 of the method by which the selecting unit 360 of the production control computer 300 selects another workpiece W is similar to steps ST1, ST2, and step ST3 of the method by which the selecting unit 60 of the numerical controller 1 that is the selecting device according to the first embodiment selects another workpiece W, the description thereof will not be repeated.

In step ST12C, the selecting unit 360 refers to the mountable tool data 57 in the production control computer 300, and determines whether or not a machining tool 207 capable of machining the workpiece W selected in step ST12 is mounted on the tool rest 202. The selecting unit 360 refers to the machining program 53 selected in step ST12 and the mountable tool data 57, and determines whether or not machining tool name information 53E that completely matches with part of the mountable tool data 57 is described in the machining program 53 selected in step ST12.

Upon determining that no machining tool name information 53E that completely matches with part of the mountable tool data 57 is described in the machining program 53 selected in step ST12, the selecting unit 360 determines that no machining tool 207 capable of machining is mounted on the tool rest 202 (step ST12C: No), and terminates the method for selecting another workpiece W.

Upon determining that machining tool name information 53E that completely matches with part of the mountable tool data 57 is described in the machining program 53 selected in step ST12, the selecting unit 360 determines that a machining tool 207 capable of machining is mounted on the tool rest 202 (step ST12C: Yes). The selecting unit 360 executes the machining program 53 selected in step ST12 to instruct to machine the workpiece W (step ST13), and returns to step ST11. In a case where a plurality of other workpieces W are machinable from a leftover material BM, the selecting unit 360 may select a workpiece W further based on priority.

Since the selecting unit 360 refers to the mountable tool data 57 and selects a workpiece W that can be machined by a machining tool 207 mounted on the automatic lathe 200 in selecting a workpiece W to be machined from a leftover material BM from among a plurality of other workpieces W, the selected workpiece W can be reliably machined from the leftover material BM, which allows the leftover material BM to be effectively used.

While the mountable tool data 57 are stored in the storage unit 350 of the production control computer 300 in the second embodiment, the mountable tool data 57 may be stored in a computer or a server in the network. In this case, the numerical controller 1 acquires the mountable tool data 57 stored in the computer or the server in the network via the network and an inputting unit 380.

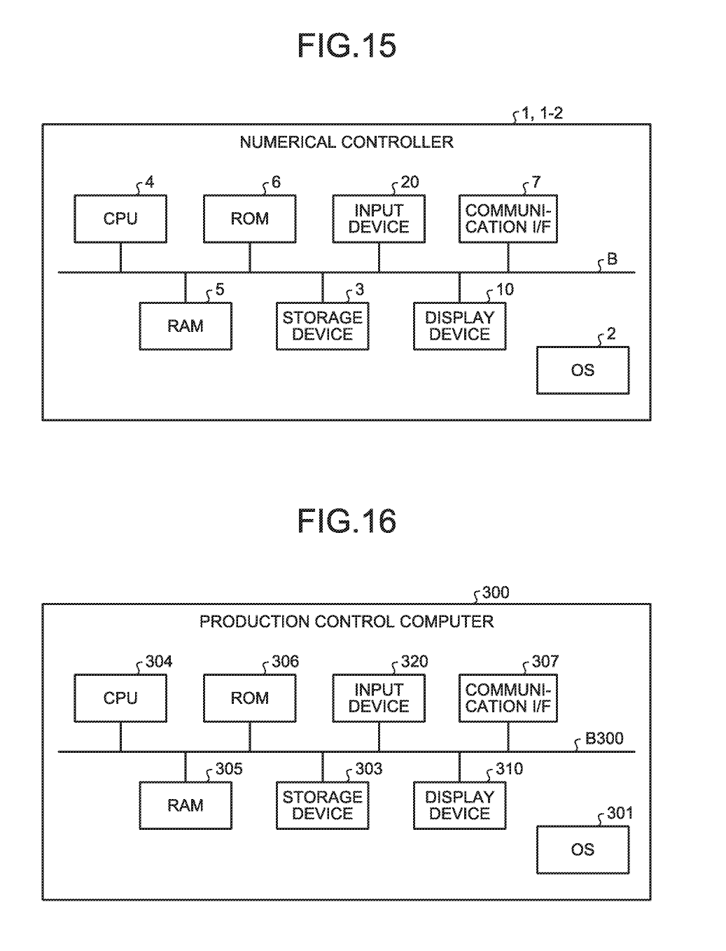

FIG. 15 is a diagram illustrating a hardware configuration of the numerical controller according to the first and second embodiments. The numerical controller 1, 1-2 according to the first and second embodiments will be described with reference to FIG. 15. The numerical controller 1, 1-2 according to the embodiments is a computer that executes computer programs on an operating system (OS) 2, and includes the display device 10, the input device 20, a storage device 3, a central processing unit (CPU) 4, a random access memory (RAM) 5, a read only memory (ROM) 6, and a communication interface (I/F) 7, as illustrated in FIG. 15. The CPU 4, the RAM 5, the ROM 6, the storage device 3, the display device 10, the input device 20, and the communication interface 7 are connected with one another via a bus B.

The functions of the screen processing unit 31, the input control unit 32, the parameter setting unit 33, the machine control signal processing unit 34, the interpolation processing unit 70, the acceleration/deceleration processing unit 37, and the axis data outputting unit 39 of the control computation unit 30 are implemented by the CPU 4 by executing the programs stored in the ROM 6 and the storage device 3 while using the RAM 5 as a work area. The programs are implemented by software, firmware, or combination of software and firmware.

The functions of the selecting unit 60 included in the numerical controller 1 are implemented by the CPU 4 by executing the program 56 stored in the ROM 6 and the storage device 3 while using the RAM 5 as a work area. The program 56 is implemented by software, firmware, or combination of software and firmware. While the storage device 3 is a solid state drive (SSD) or a hard disk drive (HDD) in the embodiments, the storage device 3 is not limited to an SSD or an HDD. The functions of the storage unit 50 are implemented by the ROM 6 and the storage device 3.

The display device 10 displays texts and images. In the embodiments, an example of the display device 10 is a liquid crystal display device. The communication interface 7 implements the functions of the communication unit 80. The input device 20 receives operational inputs from users. The input device 20 is constituted by a touch panel, a keyboard, a mouse, a trackball, or combination thereof.

FIG. 16 is a diagram illustrating a hardware configuration of the production control computer according to the second embodiment. The production control computer 300 according to the second embodiment will be described with reference to FIG. 16. The production control computer 300 is a computer that executes computer programs on an OS 301, and includes a display device 310 an input device 320, a storage device 303, a CPU 304, a RAM 305, a ROM 306, and a communication interface (I/F) 307, as illustrated in FIG. 16. The CPU 304, the RAM 305, the ROM 306, the storage device 303, the display device 310, the input device 320, and the communication interface 307 are connected with one another via a bus B300.

The functions of the selecting unit 360 are implemented by the CPU 304 by executing the program 56 stored in the ROM 306 and the storage device 303 while using the RAM 305 as a work area. The program 56 is implemented by software, firmware, or combination of software and firmware. While the storage device 303 is an SSD or an HDD in the embodiment, the storage device 303 is not limited to an SSD or an HDD. The functions of the storage unit 350 are implemented by the ROM 306 and the storage device 303.

The display device 310 displays texts and images. In the embodiment, an example of the display device 310 is a liquid crystal display device. The communication interface 307 implements the functions of the communication unit 370. The input device 320 implements the functions of the inputting unit 380. The input device 320 receives operational inputs from users. The input device 320 is constituted by a touch panel, a keyboard, a mouse, a trackball, or combination thereof.

The configurations presented in the embodiments above are examples of the present invention, and can be combined with other known technologies or can be partly omitted or modified without departing from the scope of the present invention.

### REFERENCE SIGNS LIST

1, 1-2 numerical controller; 30 control computation unit (control unit); 50, 350 storage unit; 53, 534, 535, 536 machining program; 53C information indicating machining length; 56 program; 57 mountable tool data; 60, 360 selecting unit; 200 automatic lathe (machine tool); 207 machining tool (tool); 300 production control computer; B bar material; BM leftover material; SK production schedule; L machining length; T, T1, T2, T3, T4 mount position.

1. A selecting device that causes a machine tool, which machines a workpiece from a bar material, to select another workpiece that the machine tool can machine from a leftover material, which is a remaining part of the bar material being machined, when a workpiece to be machined is not machinable from the leftover material, the selecting device comprising:
selecting circuitry to refer to mountable tool data indicating a tool that can be mounted on a mount position of the machine tool, and cause the machine tool to select another workpiece that is machinable by the tool that can be mounted on the machine tool, in selecting another workpiece to be machined by the machine tool from the leftover material.

2. The selecting device according to claim 1, wherein
the mountable tool data are stored as mountable tool data in a storage device in a numerical controller that controls the machine tool, and
in selecting another workpiece to be machined by the machine tool from the leftover material, the selecting circuitry refers to the mountable tool data and causes to select the workpiece that is machinable.

3. The selecting device according to claim 1, wherein
the mountable tool data are stored as part of a machining program in a storage device in a numerical controller that controls the machine tool, and
in selecting a workpiece to be machined by the machine tool from the leftover material, the selecting circuitry refers to the mountable tool data and causes to select the workpiece that is machinable.

4. The selecting device according to claim 1, wherein
the mountable tool data are stored in an external computer, and
in selecting a workpiece to be machined by the machine tool from the leftover material, the selecting circuitry refers to the mountable tool data in the external computer and causes to select the workpiece that is machinable.

5. The selecting device according to claim 1, wherein
when a plurality of other workpieces are machinable from the leftover material, the selecting circuitry causes to select the workpiece that can be machined based on priority.

6. The selecting device according to claim 1, wherein
the selecting device includes a memory to store information indicating machining lengths of a plurality of other workpieces, and
the selecting circuitry causes to select the workpiece that is machinable from the leftover material based on the information indicating the machining lengths of the workpieces stored in the memory and a length of the leftover material.

7. A selecting method comprising:
determining whether or not a workpiece to be machined by a machine tool is machinable based on a length of a leftover material of a bar material; and
when it is determined that the workpiece to be machined is not machinable, causing the machine tool to select a workpiece that is machinable from the leftover material from among other workpieces based on mountable tool data indicating a tool that can be mounted on a mount position of the machine tool.

8. A program causing a computer to execute:
a step of determining whether or not a workpiece to be machined by a machine tool is machinable based on a length of a leftover material of a bar material; and
when it is determined that the workpiece to be machined is not machinable, a step of causing the machine tool to select a workpiece that is machinable from the leftover material from among other workpieces based on mountable tool data indicating a tool mounted on a mount position of the machine tool.

9. The selecting device according to claim 2, wherein
when a plurality of other workpieces are machinable from the leftover material, the selecting circuitry causes to select the workpiece that can be machined based on priority.

10. The selecting device according to claim 3, wherein
when a plurality of other workpieces are machinable from the leftover material, the selecting circuitry causes to select the workpiece that can be machined based on priority.

11. The selecting device according to claim 4, wherein
when a plurality of other workpieces are machinable from the leftover material, the selecting circuitry causes to select the workpiece that can be machined based on priority.

12. The selecting device according to claim 2, wherein
the selecting device includes a memory to store information indicating machining lengths of a plurality of other workpieces, and
the selecting circuitry causes to select the workpiece that is machinable from the leftover material based on the information indicating the machining lengths of the workpieces stored in the memory and a length of the leftover material.

13. The selecting device according to claim 3, wherein
the selecting device includes a memory to store information indicating machining lengths of a plurality of other workpieces, and
the selecting circuitry causes to select the workpiece that is machinable from the leftover material based on the information indicating the machining lengths of the workpieces stored in the memory and a length of the leftover material.

14. The selecting device according to claim 4, wherein
the selecting device includes a memory to store information indicating machining lengths of a plurality of other workpieces, and
the selecting circuitry causes to select the workpiece that is machinable from the leftover material based on the information indicating the machining lengths of the workpieces stored in the memory and a length of the leftover material.

15. The selecting device according to claim 5, wherein
the selecting device includes a memory to store information indicating machining lengths of a plurality of other workpieces, and
the selecting circuitry causes to select the workpiece that is machinable from the leftover material based on the information indicating the machining lengths of the workpieces stored in the memory and a length of the leftover material.

16. The selecting device according to claim 9, wherein
the selecting device includes a memory to store information indicating machining lengths of a plurality of other workpieces, and
the selecting circuitry causes to select the workpiece that is machinable from the leftover material based on the information indicating the machining lengths of the workpieces stored in the memory and a length of the leftover material.

17. The selecting device according to claim 10, wherein
the selecting device includes a memory to store information indicating machining lengths of a plurality of other workpieces, and
the selecting circuitry causes to select the workpiece that is machinable from the leftover material based on the information indicating the machining lengths of the workpieces stored in the memory and a length of the leftover material.

18. The selecting device according to claim 11, wherein
the selecting device includes a memory to store information indicating machining lengths of a plurality of other workpieces, and
the selecting circuitry causes to select the workpiece that is machinable from the leftover material based on the information indicating the machining lengths of the workpieces stored in the memory and a length of the leftover material.
